(19) United States
(12) Patent Application Publication
(10) Pub. No.: US 2021/0304183 A1
(43) Pub. Date: Sep. 30, 2021

(54) MULTIPLE LOCATION-BASED AUTHENTICATION

(71) Applicant: Capital One Services, LLC, McLean, VA (US)

(72) Inventors: Anh Truong, Champaign, IL (US); Austin Walters, Savoy, IL (US); Galen Rafferty, Mahomet, IL (US); Jeremy Goodsitt, Champaign, IL (US); Vincent Pham, Champaign, IL (US)

(21) Appl. No.: 16/829,444

(22) Filed: Mar. 25, 2020

(51) Int. Cl. G06Q 20/32; G06Q 20/40; G06Q 20/42

(52) U.S. Cl. CPC G06Q 20/3224; G06Q 20/425; G06Q 20/4014

(57) ABSTRACT

Methods, systems, and apparatuses are described herein for authenticating users based on the historic location of multiple computing devices. A first location history of a first computing device may be received. One or more second computing devices may be determined based on their relationship to the first computing device, and second location histories of the one or more second computing devices may be received. Based on comparing the first location history and the second location histories, common locations may be determined. Questions may be determined based on the common locations. Based on a user response to the questions, a user may be authenticated.

### FIELD OF USE

Aspects of the disclosure relate generally to authentication of users and, more specifically, to the authentication of users using location histories of a plurality of computing devices over time.

### BACKGROUND

It is increasingly common for users to carry one or more computing devices (e.g., smartphones, laptops, tablets) throughout the day. These computing devices may be equipped with global positioning system (GPS) devices or other systems via which these devices may determine their geographic location.

Securely and conveniently authenticating users of those computing devices can be extremely difficult. Many forms of authentication are convenient, but insecure. For example, a password used to authenticate a user may be stolen or guessed. Other forms of authentication, while secure, may be cumbersome for users. For example, two-factor authentication systems may be relatively more secure than one-factor authentication methods, but users may find them difficult or annoying in practice. Thus, there is an ongoing need for improvements in methods for authenticating users.

Aspects described herein may address these and other problems, and generally improve the quality, efficiency, and speed of authenticating a user based on the location of the first computing device and locations of one or more other computing devices.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

A request, from a user, for access to a service may be received. A first location history may be received from a first computing device associated with the user. Relationships between the first computing device and a plurality of different computing devices associated with a plurality of different users may be determined. One or more second location histories may be received from the plurality of different computing devices. A plurality of common locations may be determined by comparing first geographical locations of the first location history with second geographical locations of the second location history. Based on the plurality of common locations, a question for the user may be determined. The question may be associated with a predicted interaction between the user and one or more of the plurality of different users. The user may be authenticated based on a candidate answer, submitted by the user, to the question.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a control processing system in which one or more aspects described herein may be implemented;

FIG. 2 shows an example computing device in accordance with one or more aspects described herein;

FIG. 3 shows a flow chart of a process for authenticating a user according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for authenticating users. Some computer-implemented authentication methods, such as password-based authentication, can be insecure in that, for example, passwords may be guessed or stolen. Other computer-implemented authentication methods, such as two-factor authentication, may be inconvenient to users: for example, some two-factor authentication methods require a user log in using both a password and a smartphone-generated code, which often require that the user find their smartphone before seeking authentication. Accordingly, there are ongoing efforts to improve methods of authentication to improve their security while also making them more convenient to use. While some authentication methods have used location data as one data point for considering whether a user should be authenticated, such methods are rudimentary at best. For example, some website authentication methods allow administrators to limit the ability of users to log in when their computing device's Internet Protocol (IP) address originates from a particular location (e.g., a particular country). But the growing popularity of Virtual Private Network (VPN) systems and other proxies can allow users to circumvent these methods, rendering them often ineffective.

Systems as described herein may include authenticating a user based on the location history of their computing device and one or more other computing devices that are associated with different users. The system may receive a request, by a user, for access to a service. In response to the request, a first computing device associated with the user may be sent a request for a first location history, and that first location history may comprise first indications of geographical locations of the first computing device over a first period of time. The first location history may, for example, be generated using a global positioning system associated with the first computing device, and/or may correspond to one or more access points used by the first computing device to connect to a network. The first location history may be stored for, e.g., later use. Using contact information stored on the first computing device, relationships between the first computing device and one or more second computing devices associated with one or more different users may be determined. One or more of the second computing devices may be selected. A request for one or more second location histories may be sent to the selected one or more second computing devices. The one or more second location histories may comprise second indications of second geographical locations of the one or more second computing devices over a second period of time. The first location history and the one or more second location histories may be received. One or more common locations may be determined based on comparing one or more first geographical locations of the first location history and one or more second geographical locations of the one or more second location histories. The common locations may be determined by comparing a first region associated with one or more first geographical locations of the first location history with one or more second regions associated one or more second geographical locations of the one or more second location histories. A question may be generated for the user based on the one or more common locations. The question may be associated with a predicted interaction between the user and the one or more different users. For example, the question may comprise a query as to the identity of a different user and/or a query as to a time the user met one or more second users. As another example, the question may be generated based on determining a purchase made by the user associated with one or more common locations. As another example, the question may be generated based on determining that the first computing device and the one or more second computing devices were in one or more common locations during the same part of a day. The question may be associated with a difficulty based on a time period associated with one or more of the common locations. Multiple questions may be provided, and each question may be associated with a different difficulty level. The user may provide a candidate answer to the question. Whether to provide the user access to the service may be determined based on the candidate answer to the question.

The improvements described above significantly improve the functioning of computers by improving the methods with which computing devices authenticate users. As described above, many computer-implemented authentication methods are insecure and/or inconvenient, which may introduce significant security risks. The present disclosure improves security by, using computing device location histories, asking users questions which reflect the user's lived experiences, which may be significantly harder for unauthorized users to guess and which the user may find significantly easier to answer. For example, a question asking a user who they met at a coffee shop (as evidenced by location histories indicating that both the user and the individual they met were both at the coffee shop) may be significantly easier to answer as compared to entering in a complicated twelve-character password using a smartphone touchscreen. These improvements may streamline the user authentication process, making the process quicker and, in some cases, much more computationally straightforward. For example, these improvements may permit computing devices to avoid other, more onerous authentication steps. Moreover, these improvements are significant improvements over current location-based authentication methods, which generally only use the current location of the user (e.g., as evidenced via the user's IP address) as a single data point for considering whether to authenticate the user. In contrast, the present disclosure uses the significantly more nuanced concept of common locations of multiple computing devices to determine authentication steps for the user. The present disclosure is thereby not only significantly more accurate, but also significantly more personalized.

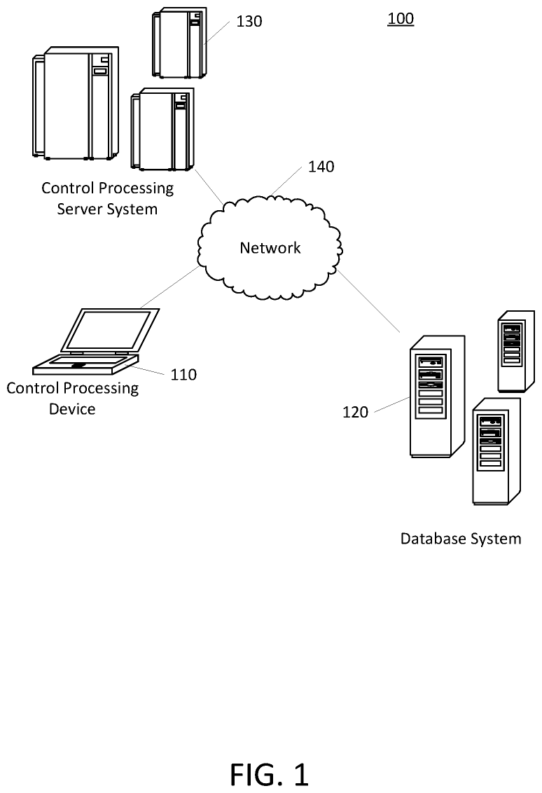

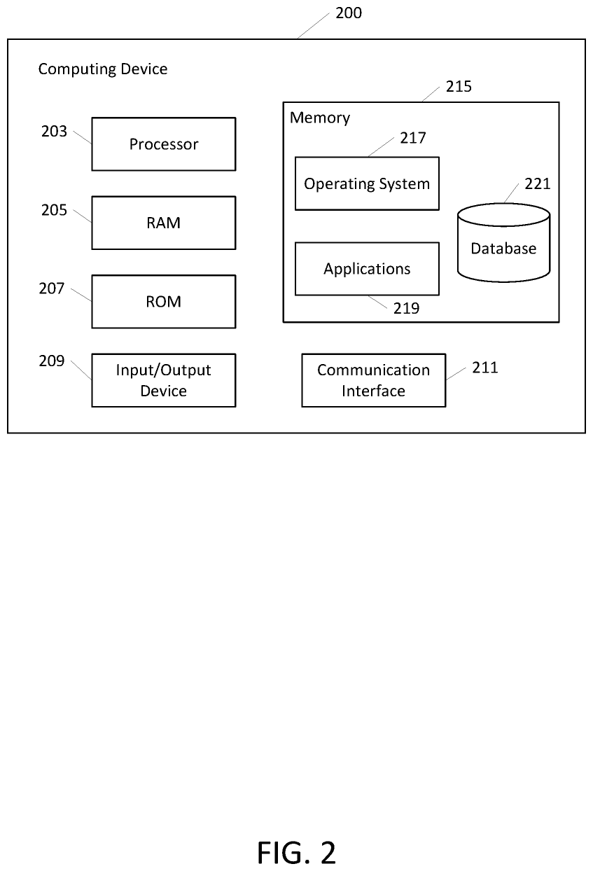

FIG. 1 shows a system 100. The system 100 may include at least one device 110, at least one database system 120, and/or at least one server system 130 in communication via a network 140. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 2.

Devices 110 may determine and store location histories, send location histories, receive authentication questions, permit users to respond to those authentication questions, and/or otherwise perform steps as described herein. Database systems 120 may store location histories, contact information, store questions and/or answers, and/or perform other steps as described herein. Databases may include, but are not limited to relational databases, hierarchical databases, distributed databases, in-memory databases, flat file databases, XML databases, NoSQL databases, graph databases, and/or a combination thereof. Server systems 130 may receive requests for access to service, send requests for location histories, receive location histories, determine relationships between computing devices, determine common locations, determine questions, receive answers, and/or otherwise perform steps as described herein. The network 140 may include a local area network (LAN), a wide area network (WAN), a wireless telecommunications network, and/or any other communication network or combination thereof.

The data transferred to and from various computing devices in a system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 100 in front of one or more computing devices such that any external devices may communicate directly with the specialized hardware.

Turning now to FIG. 2, a computing device 200 that may be used with one or more of the computational systems is described. The computing device 200 may include a processor 203 for controlling overall operation of the computing device 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computing device 200 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Communication interface 211 may include one or more transceivers, digital signal processors, and/or additional circuitry and software for communicating via any network, wired or wireless, using any protocol as described herein.

Processor 203 may include a single central processing unit (CPU), which may be a single-core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches, for example, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the invention.

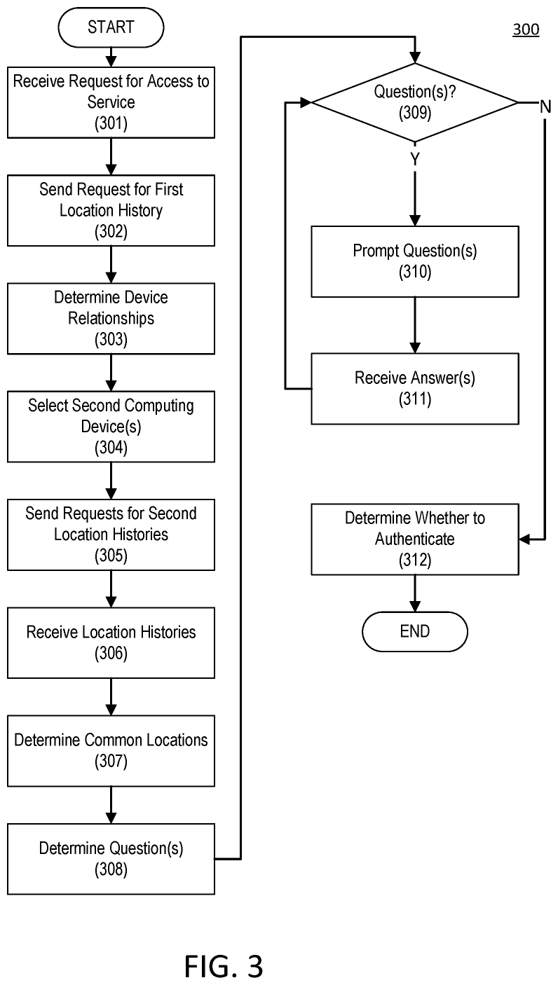

Discussion will now turn to methods of authenticating a user using location histories. FIG. 3 shows a flow chart of a process for authenticating computing devices according to one or more aspects of the disclosure. Some or all of the steps of process 300 may be performed using one or more computing devices, such as the computing device 200, as described herein. The process 300 may be all or portions of an algorithm, such as may be performed on one or more computing devices, such as the computing device 200.

In step 301, a request for access to a service may be received. The request may be received from a user. The request may be received from one or more computing devices. The request may be a request, by a user, to log in to a web page, application, or the like. The request may be associated with a telephone call made by the user, such that the request may be generated by a customer service representative receiving the call from the user. The request may comprise information about the user, such as an identification of the user, an identification of one or more computing devices associated with the user, or the like.

In step 302, a request for a first location history may be sent to a first computing device that is associated with a user. The request may be transmitted over a network, such as the network 140. The user may be the user requesting authentication in step 301. The first computing device may be determined by querying a database which correlates computing devices with users.

Location histories may comprise indications of geographical locations of a computing device over a period of time. For example, the requested first location history may, when received, comprise a plurality of indications which indicate that a user's smartphone was in a coffee shop for an hour on a Thursday. The location histories may comprise global positioning system indications, information regarding one or more access points used by a computing device to access a network, or other information which may generally indicate a time and/or location of a computing device at any given time. The location histories need not be comprehensive. For example, the location histories may comprise a time-stamped series of indications of geographical locations for a first period of time, but no entries for a second period of time. Location histories may be encrypted and/or decrypted, redacted, or otherwise obfuscated to protect user privacy. For privacy reasons, location histories may be deleted after a period of time.

Location histories may be periodically collected over time. For example, computing devices may be configured to collect and store a history of locations at periodic intervals. The location histories may be stored on a storage of a computing device and/or transmitted to another computing device.

In step 303, device relationships may be determined. The device relationships may be determined with respect to the first computing device referenced in step 302. Determining device relationships may comprise using contact information (e.g., as stored in a smartphone address book) or other similar information on a computing device to determine one or more other computing devices associated with that computing device. The device relationships may be determined using IP addresses, Media Access Control (MAC) addresses, telephone numbers, or any other information which may be used to identify one or more second computing devices. For example, determining device relationships may comprise using a user's smartphone contacts list to determine other smartphones associated with the family and/or friends of the user. Determining the device relationships may be based on querying a database which stores relationships between computing devices. For example, a database may store information related to computing devices owned by various members of the family, and the device relationships may be determined by querying the database.

Determining the device relationships may comprise determining a degree of relationship between two computing devices. For example, one device may be associated with a family member (and thus a close degree of relation), whereas another device may be associated with an acquaintance (and thus a relatively more distant degree of relation). As another example, one device may be associated with a coworker, whereas another device may be associated with a spouse. The degree of relation may indicate, for example, how likely a user is to remember their interaction with another user.

The one or more second computing device may be associated with the user of the first computing device and/or one or more second users. For example, the one or more second computing devices may be, along with the first computing device, owned and/or used by a single user. As another example, the first computing device may be owned by a first user, and the one or more second computing devices may be owned by one or more second users (e.g., family members, friends, coworkers, etc.). Where the one or more second computing devices may be associated with the same user as the first computing device, the device relationships may relate to, for example, how the devices are connected (e.g., via a wireless network), how the devices are used (e.g., which devices are used by the user at work as opposed to at home), use cases for the devices (e.g., which are used for entertainment, which are used for work, which are used more frequently than others), or the like. As one example, the device relationships for commonly-owned devices may comprise an association via one or more common wireless access points.

In step 304, one or more second computing devices may be selected. The one or more second computing devices may be selected based on the device relationships determined in step 303. For example, the one or more second computing devices may be selected based on a degree of relationship between the user of the first device and the user of the one or more second computing devices. As another example, the one or more second computing devices may be selected such that computing devices associated with family members are selected over computing devices associated with coworkers. The one or more second computing devices may be selected based on capabilities of the one or more second computing devices. For example, the one or more second computing devices may be selected based on determining that the devices are configured to collect and/or store location histories. As another example, the one or more second computing devices may be selected based on determining that the devices are currently being used, such that users of those devices would be available to permit the devices to approve transmission of a location history.

The one or more second computing devices selected may comprise one or more devices associated with the user of the first computing device and/or one or more devices associated with one or more second users. For example, the one or more second computing devices may comprise a second smartphone associated with the user of the first computing device (e.g., a company-owned smartphone that the user carries along with their personal smartphone), as well as a smartphone of a spouse of the user. Thus, the one or more second computing devices selected need not all be associated with different users and need not be all associated with the same user.

In step 305, one or more requests for one or more second location histories may be sent to the one or more second computing devices. The process for sending the requests may be the same or similar as that described in step 302.

In step 306, the first location history and/or one or more second location histories may be received. The first location history and/or one or more second location histories may be in any format. For example, the first location history may be a series of GPS coordinates, a series of recently-accessed wireless access points, or the like.

As part of receiving the first location history and/or the one or more second location histories, the location histories may be stored. By storing these location histories, they may be used in the future without requesting and retrieving the location histories. For example, after the process shown in FIG. 3, in response to a second request for access to the service, steps 302 through 306 may be omitted because the location histories may already be stored.

In step 307, based on the first location history and/or the one or more second location histories, common locations may be determined. Common locations may comprise one or more geographical locations and/or regions which are common to the first location history and/or the one or more second location histories. There may be one or more common locations over a period of time.

Common locations need not be the exact same. For example, determining common locations may comprise determining one or more first regions associated with one or more first geographic locations of the first location history, determining one or more third regions associated with one or more second geographic locations of the second location history, and comparing the first regions and the second regions to see if any overlap occurred.

Determining the common locations may comprise determining, by comparing the first location history and the one or more second location histories, that two computing devices (e.g., the first computing device and the one or more second computing devices) were in the same region around the same time period and/or for a predetermined period of time (e.g., the same part of a day, such as afternoon on a particular Wednesday). For example, determining common locations may comprise determining that two computing devices were in the same location for longer than twenty minutes and/or were in the same location for five minutes on a Wednesday afternoon. In this manner, brief meetings (e.g., two users walking past one another briefly) might not be used as the basis for questions, as such brief meetings may be hard for the user to remember. The size and nature of the regions may depend on the fidelity of the location indications, the frequency with which the regions change, and the like. For example, a region may be a particular room in a building, a building, a city block, or the like.

Determining the common locations may comprise determining instances where the first location history and/or the one or more second location histories indicate common travel paths. For example, the first location history and/or the one or more second location histories may comprise indications which move in approximately the same manner (e.g., in the same direction, along the same road, along the same path) at the same time. Such movement may indicate that computing devices were traveling together. For example, the two computing devices may be in the same vehicle traveling down the road.

In step 308, one or more questions may be determined. The one or more questions may be determined based on the common locations. The one or more questions may be associated with users of the one or more second computing devices. For example, the one or more questions may ask a first user where they met another user (e.g., a particular location, such as a coffee shop), when they met another user (e.g., a particular hour, a time of day, a date), who they met (e.g., the other user's name, how the first user met the other user), why they met the other user (e.g., if they met the user for a meeting on their calendar), or the like.

Questions may be associated with difficulty levels. Some questions may be more difficult in that they ask more specific questions, such as a particular time one user met another user, the name of a coffee shop, or the like. Some questions may be easier in that they ask more general or easily guessed questions, such as whether the user went to a coffee shop on a particular day. Some questions may be easier or more difficult based on the age of information associated with the question: for example, questions about more recent information may be more easily remembered than questions about older information. Based on the difficulty level of a first question, a second question may be generated. For example, based on the first question being too easy (and thus potentially unreliable from an authentication perspective), a second, slightly more difficult question may be generated and presented after the first question.

Questions may be associated with activities performed by a user and/or may be based on additional information. Questions may be further based on purchase information associated with a user. For example, a user may be asked what type of drink they purchased at a coffee shop on a particular day. Questions may further be based on activity information associated with one or more computing devices. For example, a user may be asked what music they listened to when in their garage. Questions may further be based on the activity of other users. For example, information associated with a second user may be retrieved from a second computing device, and a user may be asked what the user did (e.g., what music the second user listened to, what the second user purchased at a coffee shop) when the user met them.

Questions may be generated based on the likelihood that a user may remember the answer. Older events (e.g., a meeting two weeks ago) may be less easily remembered by a user than more recent events (e.g., a meeting yesterday). As such, the question may be generated to be more generic and/or easier if the event in question is older (e.g., “Which of these people did you meet last week?”), whereas the question may be generated to request more specific information (e.g., “What did you order at the coffee shop yesterday?”) if the event in question is more recent.

Step 309 determines whether any of the questions determined in step 308 remain. If so, the process proceeds to step 310, where the user is prompted with the question. If not, the process proceeds to step 312.

In step 310, one or more users are prompted with one or more of the questions determined in step 308. The one or more questions may be prompted using a computing device, such as the first computing device associated with the first location history. One or more questions may be portrayed at the same time and/or sequentially. The questions may be presented using a user interface which may permit a user to answer using one or more input methods. A user may be permitted to answer the one or more questions textually, using voice input, by using a multiple choice input, or the like.

The user which is prompted with the questions need not be the user associated with the request for authentication. For example, in response to a first user requesting authentication, a second user may be asked questions about when the first user and the second user recently met. In this manner, a second user may participate in the authentication of a first user. This may have security advantages: by requiring a second user (e.g., a spouse, using their personal computing device) to authenticate a first user, the risk that an unauthorized user is able to singlehandedly breach a system may be mitigated.

In step 311, one or more answers to the question may be received. The answers may be in a textual format, a Boolean format, or any format appropriate in response to the question presented in step 310. For example, the one or more answers may indicate an identity of an individual, a time that the user met an individual, where the user met the individual, or the like. The process then returns to step 309 to determine if any further questions remain.

In step 312, based on the one or more answers in step 309, it may be determined whether to authenticate a user. The user authenticated may be the same or a different user than the one associated with the request for access to the service, and may be the same or different than the user answering the questions in step 311. Determining whether to authenticate the user may comprise determining whether the answers were correct. The answers need not be perfectly correct to authenticate the user: for example, a generic answer (e.g., “3 PM”) to a specific question (e.g., “When did you meet your parents today?”) may be acceptable when the actual answer stored by the system (e.g., “3:05 PM EST”) is slightly more specific. For example, determining that a particular question was answered correctly may comprise determining whether a candidate answer and the correct answer match within a predetermined threshold.

An example of FIG. 3 from the perspective of a user device illustrates how a user may experience the benefits of this disclosure. A first computing device, such as a user's smartphone, may store a first location history indicating various locations that the first location has been over a period of time. The first computing device may also store contact information which comprises an indication of a second user, such as the user's family member or friend. The first computing device may, at the request of the user, send a request for access to a service to a second computing device. The first computing device may, after sending the request, the first location history and the contact information. The first computing device may receive a question that was based on the first location and a second location history, and the second location history may correspond to a third computing device associated with the second user. As such, the question may have been generated (e.g., by a server) based on common locations determined between the first location history and the second location history. The question may be associated with a predicted interaction between the user and the second user. The first computing device may send a candidate answer to the question, and the first computing device may receive an indication as to whether the user is permitted to access the service.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A computer-implemented method comprising:
receiving, by a first computing device, an indication of a request, associated with a user, for access to a service;
sending, by the first computing device and to a second computing device associated with the user, a first request for a first location history, wherein the first location history comprises first indications of first geographical locations of the second computing device over a first period of time;
determining contact information, stored by the second computing device, comprising indications of a plurality of different users;
determining, by the first computing device and based on the contact information, relationships between the second computing device and a plurality of different computing devices associated with the plurality of different users;
selecting, by the first computing device and from the plurality of different computing devices, a third computing device associated with a second user of the plurality of different users;
sending, by the first computing device and to the third computing device, a second request for a second location history, wherein the second location history comprises second indications of second geographical locations of the third computing device over a second period of time;
receiving, by the first computing device and from the second computing device, the first location history;
receiving, by the first computing device and from the third computing device, the second location history;
determining, by the first computing device, a plurality of common locations by determining that at least a portion of the first geographical locations correspond to at least a portion of the second geographical locations;
determining, by the first computing device, a question for the user based on at least one of the plurality of common locations, wherein the question is associated with a predicted interaction between the user and the second user while the user and the second user were at the at least one of the plurality of common locations;
receiving, by the first computing device and from the user, a candidate answer to the question; and
determining, by the first computing device and based on the candidate answer to the question, whether to provide the user access to the service.

2. The computer-implemented method of claim 1, wherein determining the question comprises:
determining, by the first computing device, that the second computing device and the third computing device were in the at least one of the plurality of common locations during a same part of a day.

3. The computer-implemented method of claim 1, further comprising:
determining, by the first computing device and based on determining an age of information associated with the question for the user, a difficulty level associated with the question for the user;
determining, by the first computing device and based on the difficulty level, a second question for the user; and
receiving, by the first computing device and from the user, a second candidate answer to the second question, wherein determining whether to provide the user access to the service is based on the second candidate answer.

4. The computer-implemented method of claim 1, wherein the first location history corresponds to one or more access points used by the second computing device to connect to a network.

5. The computer-implemented method of claim 1, wherein determining the question comprises:
determining, by the first computing device, a purchase made by the user during a time period associated with the plurality of common locations, wherein the question is associated with the purchase.

6. The computer-implemented method of claim 1, wherein the question is associated with an identity of the second user.

7. The computer-implemented method of claim 1, further comprising:
storing, by the first computing device and after determining whether to provide the user access to the service, the first location history.

8. The computer-implemented method of claim 1, wherein the first indications are generated using a global positioning system associated with the second computing device.

9. The computer-implemented method of claim 1, wherein determining the plurality of common locations comprises:
determining, by the first computing device, a first region associated with at least one of the first geographical locations;
determining, by the first computing device, a second region associated with at least one of the second geographical locations; and
determining, by the first computing device, that at least a portion of the first region corresponds to at least a portion of the second region.

10. The computer-implemented method of claim 1, wherein the candidate answer indicates a time the user met the second user.

11-20. (canceled)

21. A computing device comprising:
one or more processors; and
memory storing instructions that, when executed by the one or more processors, cause the computing device to:
receive an indication of a request, associated with a user, for access to a service;
send, to a second computing device associated with the user, a first request for a first location history, wherein the first location history comprises first indications of first geographical locations of the second computing device over a first period of time;
determine contact information, stored by the second computing device, comprising indications of a plurality of different users;
determine relationships between the second computing device and a plurality of different computing devices associated with the plurality of different users;
select, from the plurality of different computing devices, a third computing device associated with a second user of the plurality of different users;
send, to the third computing device, a second request for a second location history, wherein the second location history comprises second indications of second geographical locations of the third computing device over a second period of time;
receive, from the second computing device, the first location history;
receive, from the third computing device, the second location history;
determine a plurality of common locations by determining that at least a portion of the first geographical locations correspond to at least a portion of the second geographical locations;
determine a question for the user based on at least one of the plurality of common locations, wherein the question is associated with a predicted interaction between the user and the second user while the user and the second user were at the at least one of the plurality of common locations;
receive, from the user, a candidate answer to the question; and
determine, based on the candidate answer to the question, whether to provide the user access to the service.

22. The computing device of claim 21, wherein the instructions, when executed by the one or more processors, cause the computing device to determine the question by causing the computing device to:
determine that the second computing device and the third computing device were in the at least one of the plurality of common locations during a same part of a day.

23. The computing device of claim 21, wherein the instructions, when executed by the one or more processors, cause the computing device to:
determine, based on determining an age of information associated with the question for the user, a difficulty level associated with the question for the user;
determine, based on the difficulty level, a second question for the user; and
receive, from the user, a second candidate answer to the second question, wherein determining whether to provide the user access to the service is based on the second candidate answer.

24. The computing device of claim 21, wherein the first location history corresponds to one or more access points used by the second computing device to connect to a network.

25. The computing device of claim 21, wherein the instructions, when executed by the one or more processors, cause the computing device to determine the question by causing the computing device to:
determine a purchase made by the user during a time period associated with the plurality of common locations, wherein the question is associated with the purchase.

26. A non-transitory computer-readable medium storing instructions that, when executed, cause a computing device to further perform the steps of:
receiving an indication of a request, associated with a user, for access to a service;
sending, to a second computing device associated with the user, a first request for a first location history, wherein the first location history comprises first indications of first geographical locations of the second computing device over a first period of time;
determining contact information, stored by the second computing device, comprising indications of a plurality of different users;
determining relationships between the second computing device and a plurality of different computing devices associated with the plurality of different users;
selecting, from the plurality of different computing devices, a third computing device associated with a second user of the plurality of different users;
sending, to the third computing device, a second request for a second location history, wherein the second location history comprises second indications of second geographical locations of the third computing device over a second period of time;
receiving, from the second computing device, the first location history;
receiving, from the third computing device, the second location history;
determining a plurality of common locations by determining that at least a portion of the first geographical locations correspond to at least a portion of the second geographical locations;
determining a question for the user based on at least one of the plurality of common locations, wherein the question is associated with a predicted interaction between the user and the second user while the user and the second user were at the at least one of the plurality of common locations;
receive, from the user, a candidate answer to the question; and
determining, based on the candidate answer to the question, whether to provide the user access to the service.

27. The non-transitory computer-readable medium of claim 26, wherein the instructions, when executed, cause the computing device to determine the question by causing the computing device to further perform the steps of:
determining that the second computing device and the third computing device were in the at least one of the plurality of common locations during a same part of a day.

28. The non-transitory computer-readable medium of claim 26, wherein the instructions, when executed, cause the computing device to perform the steps of:
determining, based on determining an age of information associated with the question for the user, a difficulty level associated with the question for the user;
determining, based on the difficulty level, a second question for the user; and
receiving, from the user, a second candidate answer to the second question, wherein determining whether to provide the user access to the service is based on the second candidate answer.

29. The non-transitory computer-readable medium of claim 26, wherein the first location history corresponds to one or more access points used by the second computing device to connect to a network.

30. The non-transitory computer-readable medium of claim 26,
wherein the instructions, when executed, cause the computing device to determine the question by causing the computing device to perform the steps of:
determining a purchase made by the user during a time period associated with the plurality of common locations, wherein the question is associated with the purchase.
